(19) United States
(12) Patent Application Publication
(10) Pub. No.: US 2013/0232434 A1
(43) Pub. Date: Sep. 5, 2013

(54) SYSTEM AND METHOD FOR DISPLAYING ARCHITECTURAL WINDOW COVERINGS THROUGH A GRAPHICAL USER INTERFACE

(71) Applicant: Vinny Grosso, Coxsackie, NY (US)

(72) Inventor: Vinny Grosso, Coxsackie, NY (US)

(21) Appl. No.: 13/778,934

(22) Filed: Feb. 27, 2013

Related U.S. Application Data
(60) Provisional application No. 61/605,249, filed on Mar. 1, 2012.

(51) Int. Cl. G06F 3/0482

(52) U.S. Cl. CPC G06F 3/0482
USPC 715/771

(57) ABSTRACT

The present invention includes a solution for providing a suite of graphical representations to give consumers a more accurate sense of color, opacity and texture when purchasing window coverings.

### CROSS REFERENCE TO RELATED APPLICATIONS

This application claims priority to U.S. Provisional Application No. 61/605249, filed on Mar. 1, 2012 and entitled “SYSTEM AND METHOD FOR DISPLAYING ARCHITECTURAL WINDOW COVERINGS THROUGH A GRAPHICAL USER INTERFACE.” This application is related in some aspects to U.S. Pat. No. 7,881,973 issued on Feb. 1, 2011, and entitled “METHOD, SYSTEM AND PROGRAM PRODUCT FOR SELECTING WINDOW COVERINGS”, which is incorporated by reference herein in its entirety, and U.S. Provisional Patent Application No. 61/605522, filed on Mar. 1, 2012 and entitled “SYSTEM AND METHOD FOR SELECTING ARCHITECTURAL WINDOW COVERINGS BASED ON A WEIGHTED CALCULATION OF USER PREFERENCES”, which is incorporated by reference herein in its entirety.

### FIELD OF THE INVENTION

The present invention relates generally to window coverings, and more specifically relates to a method, system and program product for displaying architectural window coverings through a graphical user interface.

### BACKGROUND OF THE INVENTION

When a consumer is making a decision on purchasing architectural window coverings they often prefer to have a physical representation or swatch sample to visualize how the finished product will look and feel in their intended setting. Architectural window covering sales via the internet can be stalled if a consumer requires a “swatch” before committing to a purchase.

### SUMMARY OF THE INVENTION

The present invention includes a solution for providing a suite of graphical representations to give consumers a more accurate sense of color, opacity and texture when purchasing window coverings.

### BRIEF DESCRIPTION OF THE DRAWINGS

These and other features of this invention will be more readily understood from the following detailed description of the various aspects of the invention taken in conjunction with the accompanying drawings in which:

FIG. 1

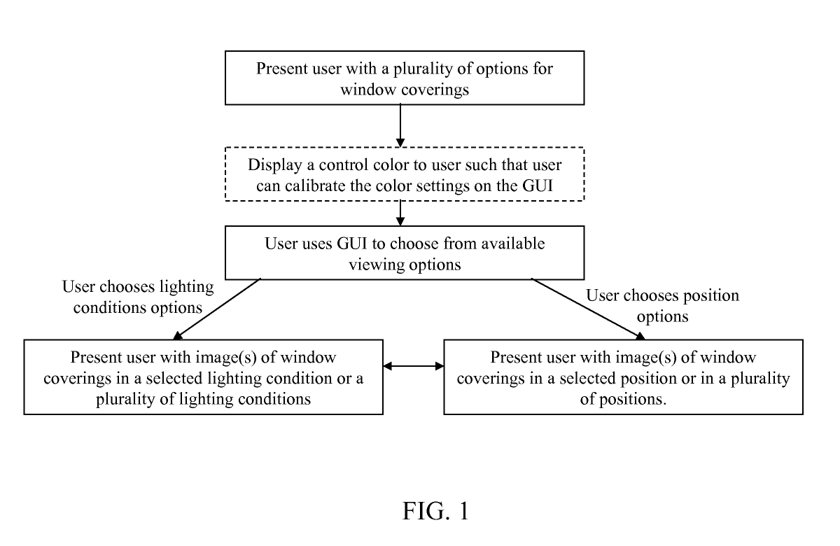

FIG. 2 shows an illustrative environment including a system for displaying architectural window coverings through a graphical user interface according to an embodiment of the invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Aspects of the present invention include providing a solution for providing a suite of graphical representations to give consumers a more accurate sense of color and texture when purchasing window coverings.

Consumers often use online or electronic purchasing methods to select and purchase architectural window coverings for their home or business. In these electronic transactions, an image of the window coverings available for purchase are displayed to a potential purchaser through a graphical user interface (GUI). The purchaser (also referred to herein as the consumer or the user), chooses which window coverings to purchase based, in part, on these images. However, color can be a challenging attribute of a window covering to convey to the consumer. There are at least three primary conditions that are currently not adequately represented in a GUI type sale: (1) color variation due to lighting conditions; (2) color variation due to product condition (e.g., raised, lowered, compacted, expanded, articulated, lined, unlined); and (3) color variation due to monitor (GUI) settings. Embodiments of the invention disclosed herein address these three conditions as follows:

For the first condition, color variation due to lighting conditions can be a challenge not just for a GUI representation of the product, but because when a consumer has a physical swatch, often they are only able to view it one light condition, i.e., the present one. GUI representations are almost always a photograph from a studio, under a set lighting condition. The lighting condition remains consistent from one product to another so the relative color between products can be accurately depicted on a GUI. However, a consumer is generally more interested in how a particular product will look in different conditions versus relative to another product. Aspects of this invention depict the relative color effect from variable light conditions. These light conditions can be back light or front light or a combination thereof. For example, a plurality of images of a selected product can be shown to a consumer, each image taken in a different lighting condition. In this way, a consumer can see what a product would look like in low lighting, in bright lighting, in direct sunlight, in candle light, at night, etc.

For the second condition, the color variation due to product condition can also be a challenge for both GUI representations as well as swatches. The visual color effect of a product often changes as the product is manipulated into different positions such as open and closed. For example the color of a cellular fabric shade appears much darker when compressed than when it is partially or fully expanded. Aspects of this invention account for the types of condition changes a product has, and depicts a relative color variance for those conditions. Again, a plurality of images of a product can be shown to a consumer, each image showing the product in a different position. For example, an image of a blind fully compressed, partially compressed, fully open, etc. This aspect of the invention can also be combined with the other aspects of the invention discussed herein. For example, both the condition of the product and the lighting condition can be varied in each image. Any number of permutations are therefore possible, e.g., a compressed shade in direct sunlight, a compressed shade in low lighting, an open shade in low lighting, a semi-closed shade in low lighting, etc.

For the third condition, this challenge is for GUI representations of product on a consumer's computer. The color settings on GUI vary from user to user and do not necessarily represent the source color attributes accurately. Aspects of this invention display control colors that can be manipulated by the consumer to accurately display on their GUI without changing their hardware settings. For example, an image of a “control” color can be provided, and a user can calibrate their settings on their GUI so that the “control” color looks accurate. So if a white color is shown as the control color, a user can adjust their display or the source control color such that the white color appears to be a true white. Then a user can have confidence that they are viewing a product in its true color. In this way, the variation in control colors is incorporated into the product representation providing the consumer with a better idea of the actual color.

As will be appreciated by one skilled in the art, the systems and methods described herein may be embodied as a system(s), method(s) or computer program product(s). Accordingly, embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the present invention are described herein with reference to method steps and/or actions, and it is understood that each step and/or action can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the method description.

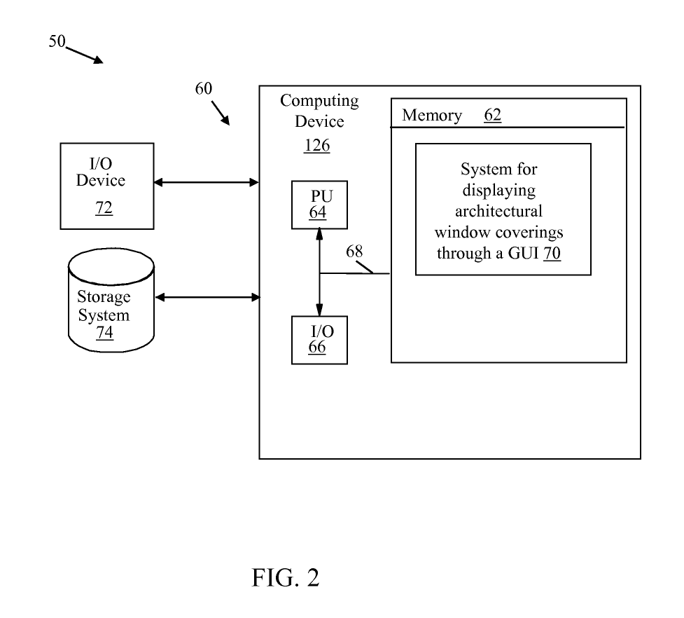

Turning to FIG. 2, an illustrative environment 50 including a system 70 for displaying architectural window coverings through a graphical user interface is shown according to embodiments of the invention. Environment 50 includes a computer infrastructure 60 that can perform the various processes described herein. In particular, computer infrastructure 60 is shown including a computing device 126 that comprises the system 70 for displaying architectural window coverings through a graphical user interface, which enables computing device 126 to give consumers a more accurate sense of color and texture when purchasing window coverings online.

Computing device 126 is shown including a memory 62, a processor (PU) 64, an input/output (I/O) interface 66, and a bus 68. Further, computing device 126 is shown in communication with an external I/O device/resource 72 and a storage system 74. As is known in the art, in general, processor 64 executes computer program code, such as system 70 that is stored in memory 62 and/or storage system 74. While executing computer program code, processor 64 can read and/or write data, such as values obtained from set of sensors 103, connected to one or more components in the power generation system 100. Bus 68 provides a communications link between each of the components in computing device 126. I/O device 72 can comprise any device that enables a user to interact with computing device 126 or any device that enables computing device 126 to communicate with one or more other computing devices. Input/output devices (including but not limited to keyboards, displays, pointing devices, etc.) can be coupled to the system either directly or through intervening I/O controllers.

Computing device 126 can comprise any general purpose computing article of manufacture capable of executing computer program code installed by a user (e.g., a personal computer, server, handheld device, etc.). However, it is understood that computing device 126 and system 70 for displaying architectural window coverings through a graphical user interface are only representative of various possible equivalent computing devices that may perform the various process steps of the disclosure. To this extent, in other embodiments, computing device 126 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 60 is only illustrative of various types of computer infrastructures for implementing the disclosure. For example, in one embodiment, computer infrastructure 60 comprises two or more computing devices (e.g., a server cluster) that communicate over any type of wired and/or wireless communications link, such as a network, a shared memory, or the like, to perform the various process steps of the disclosure. When the communications link comprises a network, the network can comprise any combination of one or more types of networks (e.g., the Internet, a wide area network, a local area network, a virtual private network, etc.). Network adapters may also be coupled to the system to enable the data processing system to become coupled to other data processing systems or remote printers or storage devices through intervening private or public networks. Modems, cable modem and Ethernet cards are just a few of the currently available types of network adapters. Regardless, communications between the computing devices may utilize any combination of various types of transmission techniques.

As previously mentioned and discussed further herein, system 70 for displaying architectural window coverings through a graphical user interface has the technical effect of enabling computing infrastructure 60 to perform, among other things, the solution of giving consumers a more accurate sense of color and texture when purchasing window coverings online, as described herein. It is understood that some of the various components shown in FIG. 2 can be implemented independently, combined, and/or stored in memory for one or more separate computing devices that are included in computer infrastructure 60. Further, it is understood that some of the components and/or functionality may not be implemented, or additional schemas and/or functionality may be included as part of environment 50.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A method for displaying architectural window coverings through a graphical user interface (GUI) during an electronic purchase, comprising:
presenting a user with a plurality of images of an architectural window covering, wherein each image depicts at least one of:
the architectural window covering in a different lighting condition; and
the architectural window covering in a different position.

2. The method of claim 1, further displaying a control color image to the user such that a user can use the control color image to calibrate the color settings on the GUI or source data.

3. The method of claim 2, displayed in GUI that communicates with a source database to ensure accurate and current depictions.

4. A method for displaying architectural window coverings through a graphical user interface (GUI) during a consultation, comprising:
presenting a user with a plurality of images of an architectural window covering, wherein each image depicts at least one of:
the architectural window covering in a different lighting condition; and
the architectural window covering in a different position.

5. The method of claim 4, further displaying a control color image to the user such that a user can use the control color image to calibrate the color settings on the GUI or source data.

6. The method of claim 5, displayed in GUI that communicates with a source database to ensure accurate and current depictions.

7. The method of claim 6, that also provides technical details regarding the product.
